(19) United States
(12) Patent Application Publication
(10) Pub. No.: US 2009/0229114 A1
(43) Pub. Date: Sep. 17, 2009

(54) METHOD OF MANUFACTURING COLLECTOR AND METHOD OF MANUFACTURING ELECTRIC POWER STORAGE APPARATUS

(76) Inventor: Kenji Kimura, Aichi (JP)

Correspondence Address: KENYON & KENYON LLP, 1500 K STREET N.W., SUITE 700, WASHINGTON, DC, 20005, US

(21) Appl. No.: 12/444,629

(22) PCT Filed: Nov. 8, 2007
(86) PCT No.: PCT/JP2007/071729

§ 371 Date: Apr. 7, 2009

(30) Foreign Application Priority Data
Nov. 15, 2006 (JP) 2006-309141

(51) Int. Cl. H01M 6/02

(52) U.S. Cl. 29/623.1

(57) ABSTRACT

A method of manufacturing a collector connected to a tab and having a thickness reduced with increasing distance from the tab, wherein the collector is formed by stacking a plurality of collector plates having different dimensions in a direction orthogonal to the direction of the thickness.

### TECHNICAL FIELD

The present invention relates to a method of manufacturing a collector which has a thickness reduced with increasing distance from a tab.

### BACKGROUND ART

There is a growing need for environmentally aware vehicles such as electric vehicles and hybrid vehicles in recent years. Power sources for driving motors, serving as the key in commercializing the vehicles, have been actively developed. Bipolar type batteries having high power density have attracted attention as one of the power sources of this type for driving motors.

If the bipolar type battery is charged and discharged, electric current flowing through a collector of the outermost layer is concentrated around a connecting portion to a tab for drawing the electric current. Within a electric power generation element, the flowing amount of electric current varies depending on the position of the connecting portion to the tab.

When such variations of the current density occur, in the area of a higher current density, deterioration of the battery proceeds due to consumption of active materials and production of heat. The problem becomes more significant as a larger amount of electric current flows through the power generation element, so that some countermeasures should be taken simultaneously with the technical development for improving the electric power density.

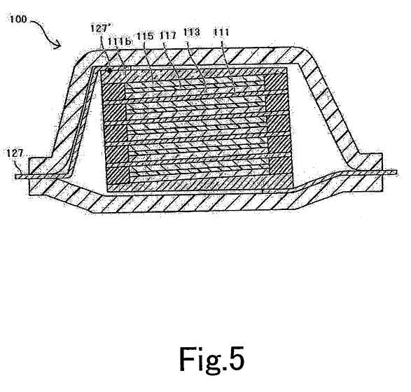

Patent Document 1 has disclosed a method for preventing variations in current density as described below. FIG. 5 is a section view showing a conventional bipolar type battery.

A bipolar type battery 100 is formed by stacking a number of bipolar type electrodes with electrolyte layers 117 interposed therebetween. The bipolar type electrode has a positive electrode layer 113 formed on one surface of a collector 111 which is formed to tabular and a negative electrode layer 115 formed on the other surface. A collector 111b of the outermost layer has a thickness which is monotonously reduced (in a wedge shape) in a plane direction of the collector of the outermost layer with distance from a connecting portion 127′ to a negative electrode tab 127.

The thickness dimension of the collector 111b of the outermost layer is reduced with distance from the connecting portion 127′ in this manner to prevent variations in density of electric current flowing through the collector 111b of the outermost layer. This can prevent proceeding of deterioration of the battery due to increasing the thickness production in the area around the connecting portion 127′.

In addition, Patent Document 1 has disclosed a modification of the structure of the collector of the outermost layer in paragraphs 0021 and 0022. Specifically, Patent Document 1 has disclosed an example in which the thickness dimension of the collector of the outermost layer is reduced in a curved form in a direction away from the connecting portion 127′ and an example in which the thickens dimension is reduced in steps.

[Patent Document 1] Japanese Patent Laid-Open No. 2006-85291

[Patent Document 2] Japanese Patent Laid-Open No. 2006-99973

[Patent Document 3] Japanese Patent Laid-Open No. 2000-348756

[Patent Document 4] Japanese Patent Laid-Open No. 2005-174691

[Patent Document 5] Japanese Patent Laid-Open No. 2004-139775

### DISCLOSURE OF THE INVENTION

### Problems to be Solved by the Invention

The examples described above, however, require both of a step of manufacturing the collector 111 on the flat plate and a step of manufacturing the collector 111b of the outermost layer in the wedge shape. This reduces the manufacture efficiency and increases the cost.

The same applies to the example in which the thickness of the collector 111b of the outermost layer is reduced in the curved form. For the example in which the thickness of the collector 111b of the outermost layer is reduced in steps, a specific manufacture method thereof has not been disclosed. It is contemplated that the collector 111 can be cut in steps as the method of reducing the thickness in steps. In this method, however, the cutting takes much time and the removed material of the collector is wasted, thereby increasing the cost.

To address the problems, it is an object of the present invention to manufacture a collector having a thickness reduced with distance from a tab at a low cost and with high efficiency.

### Means for Solving Problems

To solve the abovementioned problem, according to one aspect, the present invention provides a method of manufacturing a collector connected to a tab, the collector having a thickness reduced with increasing distance from the tab, wherein the collector is formed by stacking a plurality of collector plates having different dimensions in a direction orthogonal to the direction of the thickness.

Preferably, the plurality of collector plates is cut from a base-material collector foil in a strip shape. Preferably, the dimension of each of the collector plates is set in accordance with a current density in the collector.

According to another aspect, the present invention provides a method of manufacturing a collector connected to a tab, the collector having a thickness reduced with increasing distance from the tab, wherein the collector is formed by folding a collector plate.

The position where the collector plate is folded is set in accordance with a current density in the collector.

According to one aspect, the present invention provides a method of manufacturing a electric power storage apparatus including a collector connected to a tab, the collector having a thickness reduced with increasing distance from the tab, wherein the collector is formed by stacking a plurality of collector plates having different dimensions in a direction orthogonal to the direction of the thickness.

According to another aspect, the present invention provides a method of manufacturing a electric power storage apparatus including a collector connected to a tab, the collector having a thickness reduced with increasing distance from the tab, wherein the collector is formed by folding a collector plate.

### EFFECTS OF THE INVENTION

According to the present invention, the thickness of the collector can be reduced with distance from the tab by the extremely simple method in which the plurality of collector plates are stacked. This allows the power storage apparatus with suppressed variations in density of electric current flowing through the collector plates to be manufactured at a low cost and with high efficiency.

In addition, according to the present invention, the thickness of the collector can be reduced with distance from the tab by the extremely simple method in which collector plate is folded. This allows the power storage apparatus with suppressed variations in density of electric current flowing through the collector to be manufactured at a low cost and with high efficiency.

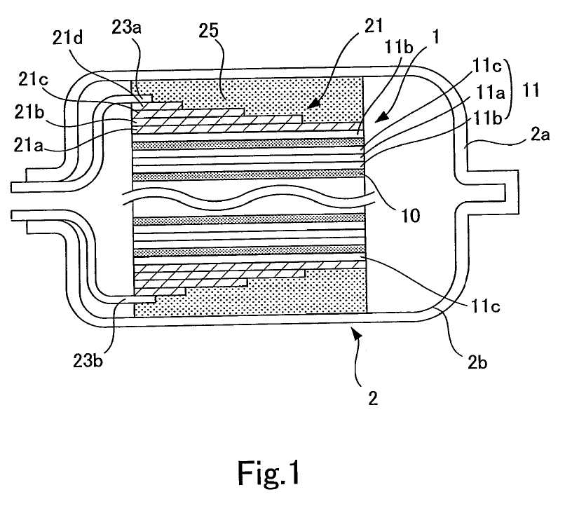

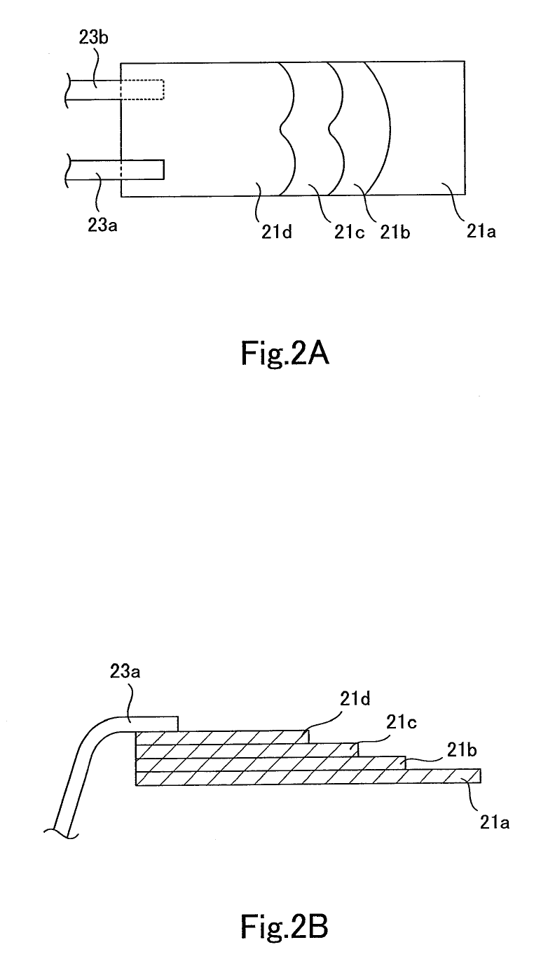

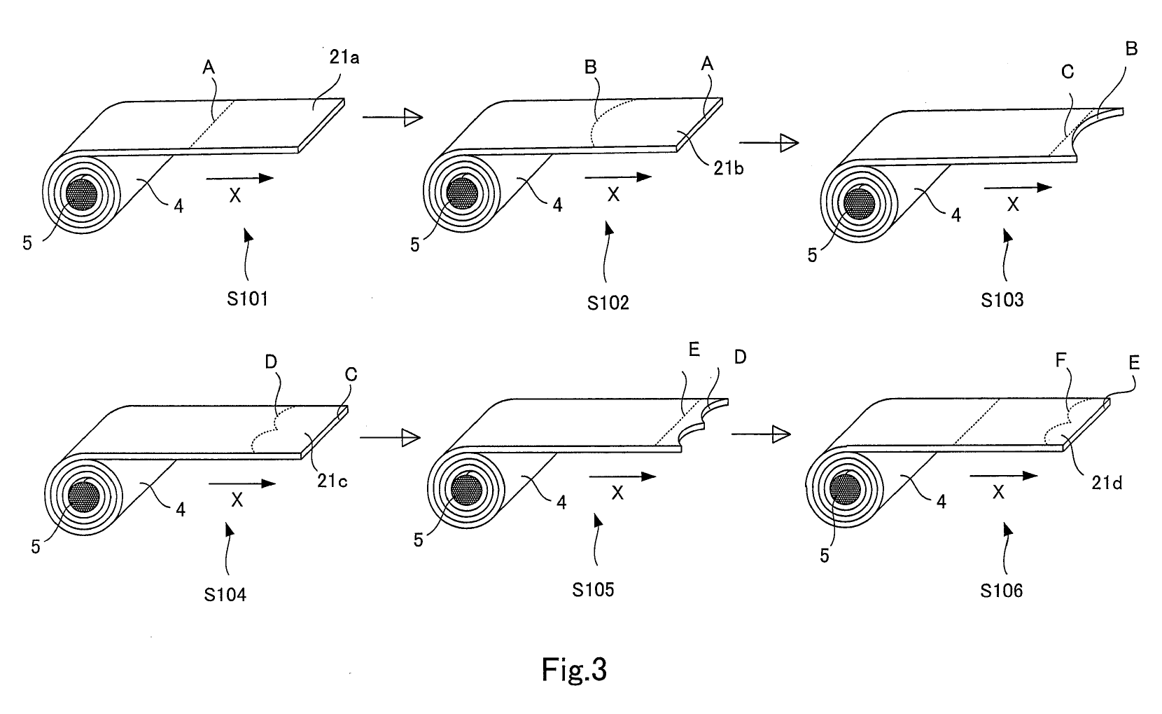

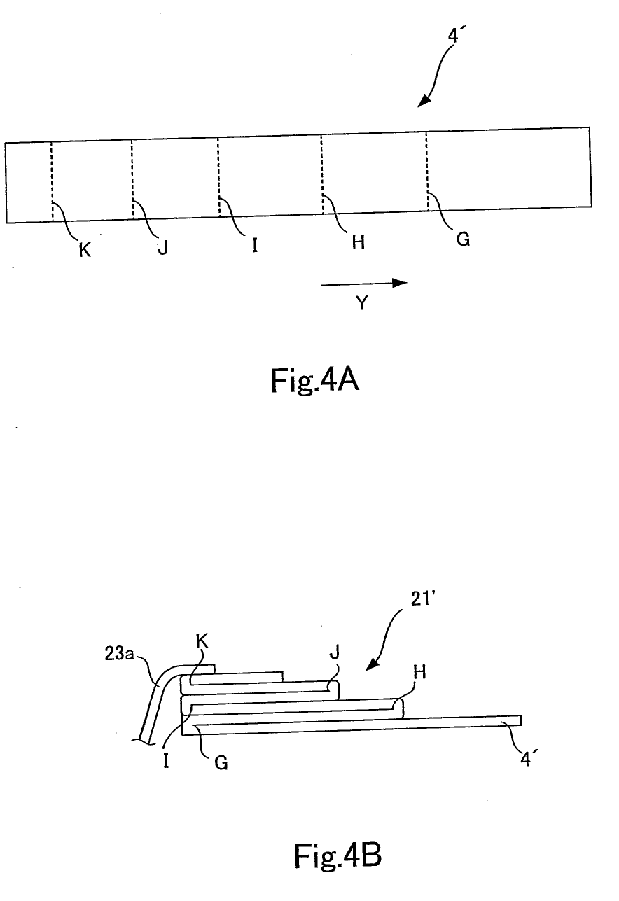

### BRIEF DESCRIPTION OF DRAWINGS

[FIG. 1] A section view showing a bipolar type battery according to Embodiment 1 of the present invention.

[FIG. 2A] A plan view showing an outermost-layer collector in Embodiment 1.

[FIG. 2B] A section view showing the outermost-layer collector in Embodiment 1.

[FIG. 3] A diagram showing steps for illustrating the procedure of manufacturing the outermost-layer collector.

[FIG. 4A] A plan view showing a base-material collector foil in Embodiment 2.

[FIG. 4B] A section view showing an outermost-layer collector in Embodiment 2.

[FIG. 5] A section view showing a conventional bipolar type battery.

### DESCRIPTION OF REFERENCE NUMERALS

1 BIPOLAR BATTERY
2 CASE
2a, 2b FILM MEMBER
4, 4′ BASE-MATERIAL COLLECTOR FOIL
10 SOLID ELECTROLYTE
11 ELECTRODE ELEMENT
11a COLLECTOR
11b POSITIVE ELECTRODE LAYER
11c NEGATIVE ELECTRODE LAYER
21, 21′ OUTERMOST-LAYER COLLECTOR
21a MAIN COLLECTOR PLATE
21b FIRST SUB COLLECTOR PLATE
21c SECOND SUB COLLECTOR PLATE
21d THIRD SUB COLLECTOR PLATE
23 TAB
25 INSULATING RESIN LAYER

### BEST MODE FOR CARRYING OUT THE INVENTION

Preferred embodiments of the present invention will hereinafter be described.

### Embodiment 1

A bipolar type battery serving as a electric power storage apparatus which is Embodiment 1 of the present invention will be described with reference to FIGS. 1 and 2. FIG. 1 is a section view showing the internal structure of the bipolar type battery. FIG. 2A is a plan view showing a collector of the outermost layer, while FIG. 2B is a section view showing the collector of the outermost layer.

As shown in FIG. 1, a bipolar type battery 1 is formed by stacking a plurality of electrode elements 11 with a solid electrolyte layer 10 interposed therebetween.

Each of the electrode elements 11 includes a collector 11a, a positive electrode layer 11b formed on one surface of the collector 11a, and a negative electrode layer 11c formed on the other surface. In other words, each of the electrode elements 11 has a bipolar type electrode structure.

Each of the electrode elements 11 placed at both ends of the bipolar type battery 1 in a stacking direction has an electrode layer (positive electrode layer or negative electrode layer) formed on only one surface thereof. In the present specification, the collector having the electrode layer formed on only one surface thereof is particularly referred to as an outermost-layer collector 21 (corresponding to a collector described in claims).

As shown in FIGS. 2A and 2B, the outermost-layer collector 21 is formed of a main collector plate 21a and three sub collector plates 21b to 21d stacked on the main collector plate 21a. The main collector plate 21a is designed to have the same dimensions as those of the collector 11a, while the sub collector plates 21b to 21d are designed to have dimensions in a plane direction thereof smaller than that of the main collector plate 21a.

The third sub collector plate 21d placed at the top of the sub collector plates 21b to 21d is electrically and mechanically connected to a tab 23a for drawing electric current. The tab is connected by ultra-sonic welding and spot welding, for example.

Thus, the thickness dimension of the outermost-layer collector 21 is reduced in steps in the plane direction of the outermost-layer collector 21 with increasing distance from the tab 23. The thickness dimension of the outermost-layer collector 21 reduced with increasing distance from the tab 23 in this manner can provide a uniform current density in the outermost-layer collector 21.

The dimensions of the sub collector plates 21b to 21d in the plane direction can be set on the basis of the measurement result of the current density in the outermost-layer collector 21. How to determine the distribution of the current density is described in Patent Document 1, so that the description thereof is omitted in the present specification.

The positive electrode layer 11b and the negative electrode layer 11c contain active materials appropriate for the positive electrode and the negative electrode, respectively. Each of the positive electrode layer 11b and the negative electrode layer 11c also contains a conductive agent, a binder, a polymer gel electrolyte for increasing ionic conduction, a polyelectrolyte, an additive or the like as required.

For example, a composite oxide of transition metal and lithium can be used as the active material of the positive electrode. Specifically, it is possible to use a Li—Co composite oxide such as LiCoO₂, a Li—Ni composite oxide such as LiNiO₂, a Li—Mn composite oxide such as spinel LiMn₂O₄, and a Li—Fe composite oxide such as LiFeO₂. It is also possible to use PbO₂, AgO, NiOOH, a phosphate compound of transition metal and lithium such as LiFePO₄, a sulfate compound, a transition metal oxide such as V₂O₅, MnO₂, MoO₃, a sulfide such as TiS₂, MoS₂. On the other hand, a metal oxide, a lithium-metal composite oxide, and carbon can be used as the active material of the negative electrode, for example.

While Embodiment 1 is described in conjunction with the use of the bipolar type electrode element 11, the present invention is not limited thereto. For example, it is possible to use an electrode element in which a positive electrode layer is formed on each surface of a collector and an electrode element in which a negative electrode layer is formed on each surface of a collector. In this case, the electrode element having the positive electrode layers formed thereon and the electrode element having the negative electrode layers formed thereon are placed (stacked) alternately with the solid electrolyte layers interposed therebetween.

A single battery including such an electrode element 11 may be used, or a plurality of such batteries may be formed into a battery set.

The collector 11a can be made of one type of metal foil or a so-called composite collector including a plurality of types of metal foil bonded together. In addition, the present invention is applicable to a collector for an electric double layer capacitor (electric power storage apparatus).

The solid electrolyte layer 10 can be made of a polymer solid electrolyte or an inorganic solid electrolyte. A known material can be used for such an electrolyte.

It is possible to use polyethylene oxide (PEO), polypropylene oxide (PPO), and a copolymer thereof, for example, as the polymer solid electrolyte. The polymer solid electrolyte contains lithium salt for ensuring ion conduction. For example, LiBF₄, LiPF₆, LiN(SO₂CF₃)₂, LiN(SO₂C₂F₅)₂, or a mixture thereof can be used as the lithium salt.

The bipolar type battery 1 is covered with a case 2 which is formed of film members 2a and 2b made of laminated film. The case 2 holds the bipolar type battery 1 with an insulating resin layer 25 interposed therebetween, and is heat-fused to provide sealing in the outer edge areas of the case 2. The tab 23 connected to the outermost-layer collector 21 extends to the outside of the case 2. This allows electric current generated in the bipolar type battery 1 to be drawn to the outside.

Typically, the laminated film can be made of polymer metal composite film consisting of heat-fusible resin film, metal foil, and rigid resin film which are stacked in this order. The heat-fusible resin film is used as a seal for housing the bipolar type battery 1. The metal foil and the rigid resin film are used for providing wetness, airtightness, and chemical resistance.

The heat-fusible resin can be made of polyethylene or ethylenevinylacetate, for example. The metal foil can be made of aluminum foil or nickel foil, for example. The rigid resin can be made of polyethyleneterephthalate or nylon, for example.

Next, a method of manufacturing the outermost-layer collector 21 (for a positive electrode) of the bipolar type battery 1 will be described with reference to FIG. 3. FIG. 3 shows steps for illustrating the method of manufacturing the outermost-layer collector 21.

A base-material collector foil 4, which serves as a base material of the outermost-layer collector 21, is wound spirally around a supply roller 5.

First, the base-material collector foil 4 is drawn from the supply roller 5 and is cut in a width direction of the base-material collector foil 4 along a broken line A to produce the main collector plate 21a of a rectangular shape in a plan view (step S101). The main collector plate 21a will be placed on the positive electrode layer 11b.

Next, the base-material collector foil 4, which has been reduced in length after the cutting of the main collector foil 4, is drawn from the supply roller 5 in a direction indicated by an arrow X. The drawn base-material collector foil 4 is cut in an arc shape along a broken line B to produce the first sub collector plate 21b having one end portion formed in the arc shape (step S102). Then, the first sub collector plate 21b is placed such that the other end portion thereof is positioned at the edge of the main collector plate 21a.

Next, the base-material collector foil 4 is cut in the width direction of the base-material collector foil 4 along a broken line C (step S103).

The base-material collector foil 4, which has been reduced in length after the cutting of the first sub collector plate 21b, is drawn from the supply roller 5 in the direction indicated by the arrow X. The drawn base-material collector foil 4 is cut in a curved shape along a broken line D to produce the second sub collector plate 21c having one end portion formed in the curved shape (step S104). Then, the second sub collector plate 21c is placed such that the other end portion thereof is positioned at the other end portion of the first sub collector plate 21b.

Next, the base-material collector foil 4 is cut in the width direction of the base-material collector foil 4 along a broken line E (step S105). The base-material collector foil 4, which has been reduced in length after the cutting of the second sub collector plate 21c, is drawn from the supply roller 5 in the direction indicated by the arrow X. The drawn base-material collector foil 4 is cut in a curved shape along a broken line F to produce the third sub collector plate 21d having one end portion formed in the curved shape (step S106). Then, the third sub collector plate 21d is placed such that the other end portion thereof is positioned at the edge of the other end portion of the second sub collector plate 21c. The collector 21 on the negative electrode side can be manufactured in the same manner.

In this manner, according to Embodiment 1, the outermost-layer collector 21 having the thickness reduced with increasing distance from the tab 23 can be manufactured by the extremely simple method in which the main collector plate 21a and the sub collector plates 21b to 21d are cut from the single base-material foil 4 and stacked in turn. This can simplify the manufacture steps to improve the efficiency of manufacture.

At steps S103 and S105, the portions of the base-material collector foil 4 are cut to smooth the shape. This can reduce the amount of the base-material collector foil 4 to be discarded as compared with the case where the thick outermost-layer collector 21 is cut and shaped into a wedge. As a result, the cost can be reduced.

The cutting steps for smoothing the shape may be performed after the cutting of the collector plates 21a to 21d from the base-material collector foil 4. It is also possible to cut the collector plates 21a to 21d by providing a shaping device which holds forms corresponding to the shapes of the collector plates 21a to 21d such that the forms can be moved up and down and by lowering the forms to the base-material collector foil 4 placed on a carry conveyor.

### Embodiment 2

Next, Embodiment 2 of the present invention will be described with reference to FIG. 4. FIG. 4A is a plan view showing a base-material collector foil 4′ in a strip shape which serves as a base material of an outermost-layer collector 21′ in Embodiment 2. FIG. 4B is a section view showing the outermost-layer collector 21′ formed by folding the base-material collector foil 4′. The outermost-layer collector 21′ in Embodiment 2 is used as a collector for drawing electric current in a bipolar type battery 1, similarly to the outermost-layer collector 21 in Embodiment 1. The base-material collector foil 4′ is made of the same material as that of the base-material collector foil 4 in Embodiment 1.

Five creases consisting of G to K shown by broken lines are formed on the base-material collector foil 4′ in a width direction of the base-material collector foil 4′. The positions of the creases are set on the basis of the distribution of current density in the outermost-layer collector 21′. Specifically, the spacing from the right end of the base-material collector foil 4′ to the crease G is set to be larger than the spacing between the creases G and H, and the spacing between the creases G and H is set to be generally the same as the spacing between the creases H and I.

The spacing between the creases G and H is set to be larger than the spacing between the creases I and J. The spacing between the creases I and J and the spacing between the creases J and K are set to be generally the same.

The spacing from the left end of the base-material collector foil 4′ to the crease K is set to be smaller than the spacing between the creases I and J.

Next, the procedure in folding the base-material collector foil 4′ to form the outermost-layer collector 21′ will be described with reference to FIG. 4B.

First, the area of the base-material collector foil 4′ on the left of the crease G is turned clockwise by using the crease G as the turning position to perform first folding. After the first folding is completed, the area of the base-material collector foil 4′ on the right of the crease H (in other words, the area on which the creases I to J are formed) is turned counterclockwise by using the crease H as the turning position to perform second folding.

Since the spacing between the creases G and H and the spacing between the creases H and I are set to be the same, the second folding causes the creases I and G to be overlapped each other one on another in the thickness direction of the base-material collector foil 4′.

After the second folding is completed, the area of the base-material collector foil 4′ on the left of the crease I (in other words, the area on which the creases J to K are formed) is turned clockwise by using the crease I as the turning position to perform third folding.

After the third folding is completed, the area of the base-material collector foil 4′ on the right of the crease J (in other words, the area on which the crease K is formed) is turned counterclockwise by using the crease J as the turning position to perform fourth folding.

Since the spacing between the creases I and J and the spacing between the creases J and K are set to be the same, the fourth folding causes the creases K and I to be overlapped each other in the thickness direction of the base-material collector foil 4′.

After the fourth folding is completed, the area of the base-material collector foil 4′ on the left of the crease K is turned clockwise by using the crease K as the turning position to perform fifth folding.

After the fifth folding is completed, the positive electrode tab 23a is connected to the area of the outermost-layer collector 21′ that has the largest thickness dimension. The outermost-layer collector 21′ on the negative electrode side can be manufactured in the same manner.

In this manner, according to the present invention, the outermost-layer collector 21′ having the thickness reduced with increasing distance from the tab 23 can be manufactured simply by folding the single base-material collector foil 4′ along the preset creases. This can simplify the manufacture steps to improve the efficiency of manufacture.

Since it is not necessary to trim the base-material collector foil 4′ into a wedge or to cut it for smoothing the shape in the manufacture steps, the entire base-material collector foil 4′ can be used as the collector. This can reduce the cost.

Embodiments 1 and 2 can be combined to manufacture the outermost-layer collector. For example, it is possible to place a plurality of sub collector plates on a folded base-material collector foil or to fold and place a base-material collector foil on sub collector plates.

The bipolar type battery manufactured in each of Embodiments 1 and 2 can be used, for example, as a electric power storage apparatus for driving a motor in an electric vehicle (EV), a hybrid vehicle (HEV), and a fuel-cell electric vehicle (FCV).

1. A method of manufacturing a collector connected to a tab, the collector having a thickness reduced with increasing distance from the tab,
wherein the collector is formed by stacking a plurality of collector plates having different dimensions in a direction orthogonal to the direction of the thickness.

2. The method of manufacturing a collector according to claim 1, wherein the plurality of collector plates are cut from a base-material collector foil in a strip shape.

3. The method of manufacturing a collector according to claim 1, wherein the dimension of each of the collector plates is set in accordance with a current density in the collector.

4. A method of manufacturing a collector connected to a tab, the collector having a thickness reduced with increasing distance from the tab,
wherein the collector including a connecting portion to the tab at an end of the collector is formed by folding a collector plate.

5. The method of manufacturing a collector according to claim 4, wherein a position where the collector plate is folded is set in accordance with a current density in the collector.

6. A method of manufacturing an electric power storage apparatus including a collector connected to a tab, the collector having a thickness reduced with increasing distance from the tab,
wherein the collector is formed by stacking a plurality of collector plates having different dimensions in a direction orthogonal to the direction of the thickness.

7. A method of manufacturing an electric power storage apparatus including a collector connected to a tab, the collector having a thickness reduced with increasing distance from the tab,
wherein the collector including a connecting portion to the tab at an end of the collector is formed by folding a collector plate.

8. The method of manufacturing a collector according to claim 4, wherein all portions of the folding of the collector placed closer to the connecting portion coincide in a plane direction of the collector plate.

9. The method of manufacturing a electric power storage apparatus according to claim 7, wherein all portions of the folding of the collector placed closer to the connecting portion coincide in a plane direction of the collector plate.

10. The method of manufacturing a collector according to claim 8, wherein a position where the collector plate is folded is set in accordance with a current density in the collector.

11. The method of manufacturing a collector according to claim 10, wherein all portions of the folding of the collector placed closer to the connecting portion coincide in a plane direction of the collector plate.
